(19) United States
(12) Patent Application Publication
(10) Pub. No.: US 2023/0420982 A1
(43) Pub. Date: Dec. 28, 2023

(54) BACKUP POWER SYSTEM FOR CABLE TELEVISION NETWORKS

(71) Applicant: TV PACK S.A. DE C.V., Guadalajara, Jalisco (MX)

(72) Inventors: Gidon Edu TER VER, Guadalajara (MX); Alejandro Gabriel Parussini, Ciudad Autónoma de Buenos Aires (AR)

(73) Assignee: SECURE POWER SYSTEM, LLC, Atizapan de Zaragoza (MX)

(21) Appl. No.: 18/253,225

(22) PCT Filed: Feb. 16, 2021
(86) PCT No.: PCT/MX2021/000004

§ 371 Date: May 17, 2023

(30) Foreign Application Priority Data
Feb. 3, 2021 (MX) MX/A/2021/001389

(51) Int. Cl. H02J 9/06; H04H 20/84

(52) U.S. Cl. CPC H02J 9/062; H04H 20/84; H02H 7/20

(57) ABSTRACT

A power backup system having a series of equipment operating together to back up a nodal branch of a cable TV network, which has been affected by a power failure, from another nodal branch with normal power flow, or from an auxiliary generator. A cable TV network includes several nodal branches, which include a variety of active equipment and components that are responsible for providing the signal to users at the appropriate levels and parameters. Through the interconnection of the different circuits, energy can be redirected from an area with electrical supply to an area where there is a power supply deficiency, and applying a good equipment positioning strategy, an integral backup system in which each branch supports the others in the network. The equipment for this system is compatible with other existing equipment and perfectly operational on its own, which enables a wide range of possible network configurations.

### CROSS REFERENCE TO RELATED APPLICATION

This application is a national stage entry of PCT/MX2021/000004 filed Feb. 16, 2021, under the International Convention claiming priority over Mexican Patent Application No. MX/a/2021/001389 filed Feb. 3, 2021.

### TECHNICAL FIELD

The present invention pertains to the technical field of power backup arrangements for cable TV networks. In particular, it pertains to the field of backup systems against power failures or outages, brownouts, etcetera.

### BACKGROUND OF THE INVENTION

Cable TV networks have evolved over time, from being an entertainment service with a limited channel grid to interactive multifunction networks that offer various services, such as Internet, on-demand services and telephony, among others. Throughout this evolution, it has been necessary to adapt the electrical supply to ensure a quality of service to the subscriber that guarantees permanent communication under any circumstances.

To ensure good signal reception in users' homes, the signal must be amplified to compensate for losses in the wiring lines. For that purpose, networks have optical nodes and amplifiers, generally known as active elements, since they must be energized.

Each active element requires a power source with tensions between 45V and 90V of alternating current (AC), so the regular distribution grid voltage, which is, depending on the local standard, 220V with 50 Hz frequency or 110V/60 Hz, must be adjusted.

Currently, the most used topologies in cable TV networks are the so-called “HFC” (Hybrid Fiber Coaxial), which combine sections of fiber optic and coaxial cable in the signal transport.

Cable TV operators' standards demand them to guarantee the service against any contingency, for instance: ±15%-25% variations in nominal voltage (according to requirement); power outages in public or private networks, partial or total (blackouts), short or long-lasting; and failures of their own power supplies; among others.

Well-known technical solutions to this problem are based on ferro-resonant saturated-core power supplies, which generate a quasi-square wave that stabilizes tension in the cable TV network within certain ranges to ensure the operation of the electronic equipment in case of oscillations in the public utility grid. In addition to this, a power inverter is used in conjunction with a set or “array” of batteries that generate a square-wave AC that can keep the voltage level in the cable TV network within acceptable values for the operation of its active elements, so that the electricity supply can be guaranteed for a period of 2 to 3 hours, depending on the network's consumption characteristics.

This solution, called U.P.S. (Uninterrupted Power Supply), even though internationally accepted as feasible and used in many technical environments, has drawbacks of various kinds, highlighting technical problems, maintenance issues, economic and environmental costs. Among the most outstanding technical problems, it can be mentioned that the ferro-resonant power supply, whether operating in normal mode or standby mode, supported by the battery array, generates great harmonic components in the voltage, many of which fall within the signal transmission band, which causes interference. This, added to the hum produced by this type of quasi-square wave in the transformer core and the transmission of upstream signals in the return band, which is the one used for the upstream and Internet, generates several kinds of interference.

The autonomy of this type of systems is a crucial point, since in the event of power outages for more than 2 hours, technical support crews must be sent with emergency power generators to feed the power supplies that are running out of battery backup. Furthermore, these batteries must be fully replaced after a period of three years due to the expiration of their useful life time, which carries a high cost and, mainly, a high level of environmental contamination, making it necessary to contemplate expensive post-use destruction processes.

An example of a well-known backup system is the one proposed in U.S. Pat. No. 5,747,888, where each nodal branch of the cable TV network is connected to a backup power supply, for example, the previously mentioned U.P.S., through an alternating current (AC) relay that switches between it and the main source when there is a failure in the electrical supply. In addition to the drawbacks explained above, another disadvantage is that each nodal branch of the network must be equipped with a unidirectional backup power supply, which increases both equipment and maintenance costs significantly, and makes implementation complicated. The solution proposed by the present invention improves upon the foregoing aspects of the prior art by delivering a backup system that does not employ batteries or ferro-resonant power supplies such as U.P.S and provides bidirectional backup between independent power supplies or networks, resulting in significant savings in equipment and subsequently operational costs.

### SUMMARY OF THE INVENTION

It is therefore the object of this invention to propose a power backup system for the electrical supply of a cable TV network that improves the known aspects in the current state of technology and overcomes the issues and disadvantages mentioned above.

This new power backup system arises as the main response to U.P.S. systems and the collateral issues caused by square and quasi-square waves produced by ferro-resonant power supplies, besides contributing to lower the environmental impact by reducing the carbon footprint, because it does not employ batteries.

In one embodiment of the present invention, the system comprises a series of equipment that work together to compensate and redirect power from an area or branch with supply to an area or branch that has been affected by a power outage, brownout or other electrical failures.

For the purposes of the present description, the terms “area”, “node”, “zone”, “branch”, “circuit” shall be considered synonyms and shall always refer to the section of a line corresponding to a service area, that is to say, the geographical location in which a power supply, a node and other active elements operate on a regular basis.

Primarily, but not limited to, the equipment required to comprise the backup system is as follows:
Sine wave power supply (EPS)
Intelligent Voltage Amplifier (IVA)
Intelligent Power Supply Switch (IPSU)
   These devices operating together can maintain a constant power supply to a cable TV network. In normal operation, two nodal circuits operate as independent networks interconnected through the IPSU devices via a “passive” coaxial cable, through which electricity will only circulate when the system enters the backup phase.

EPS power supplies have, preferably, two power output ports. In a first circuit, an “EPS 1” power supply feeds through its two ports an “IPSU 1” switch, which conveniently has 2 input ports. Similarly, in a second circuit, an “EPS 2” power supply is also connected to an “IPSU 2”. Both circuits are interconnected through a passive coaxial cable. An active coaxial cable that only carries signals could be used, even though it is not advisable.

When the network does not present any failure and the electrical supply is normal, the IPSU switches operate as power blockers to the other branches. Each IPSU switch, feeding its own branch, is permanently monitoring the proper operation of the IPSU device in the adjacent network.

In the event that a supply failure is detected, for instance, a voltage drops of more than 15% or 25%, a total outage or blackout, the EPS power supply is deactivated and the IPSU devices automatically switch connections so that the network that receives power will supply the network with problems, through the coaxial line that links both branches.

It is noticeable in these cases the phenomenon of ohmic loss or voltage drop in the coaxial cables interconnecting the nodal branches when the power supply current flows to the second circuit. To mitigate the effects of this phenomenon, an Intelligent Voltage Amplifier (“IVA”) is placed to feed the node of the second circuit that carries the signals, allowing it to operate according to the manufacturer's specifications.

The addition of the IVA amplifier also makes possible to increase the distance of wiring fed by each power supply, to extend the distance between circuits or to add more active elements to a branch, depending on the characteristics of each network design.

One of the main advantages of the present invention lies in the bidirectionality of the IVA amplifier. Since it is impossible to predict which circuit will fail, the ability of the IVA amplifier to operate indistinctly in both ways simplifies considerably the connection of the branches, the amount of equipment involved and therefore their maintenance.

In this way, regardless of which circuit has suffered the failure or supply deficiency, the IPSU switches will make the connection change and the IVA amplifier will compensate for the voltage drop, all automatically.

Eventually, electrical failures occur only in a single phase, while the other phases remain active. In these cases, the EPS power supply, which operates single-phase, can switch phases without the need for the IPSU switches to support the supply from another nodal.

In the event of both circuits being affected by a massive blackout, the EPS power supplies have an auxiliary input to connect a generator. Due to the above-mentioned features, under these circumstances, it is enough to connect a single generator to supply both nodes.

Even though for explanatory purposes, the present invention was described concerning only two network nodal branches, through a suitable design strategy and location of the equipment, mainly of the IPSU switches, a complex and reliable backup system can be achieved where the chances of requiring auxiliary generator equipment are considerably low.

### BRIEF DESCRIPTION OF THE DRAWINGS

The characteristic details of this innovative power backup system for cable TV networks are clearly displayed in the following description and accompanying figures, where common reference signs are used to indicate the parts and diagrams shown.

FIG. 1 represents a diagram of two interconnected nodal branches of a cable TV network, with the power backup system for cable TV networks according to one embodiment of the present invention, operating in normal mode, without power failures;

FIG. 2 represents a diagram of two interconnected nodal branches of a cable TV network, with the power backup system for cable TV networks according to one embodiment of the present invention, wherein the second circuit presents a power failure and is backed up by the first branch;

FIG. 3 is a diagram of the components of the IPSU smart switch, according to the present invention;

FIG. 4 is a diagram of the components of the smart voltage amplifier IVA, according to the present invention;

FIG. 5 is a block diagram explaining the operation of the EPS sine-wave power supply, according to the present invention; and

FIG. 6 is a diagram showing the connection of the EPS power supply, mainly detailing the surge suppressor module.

### DETAILED DESCRIPTION OF THE INVENTION

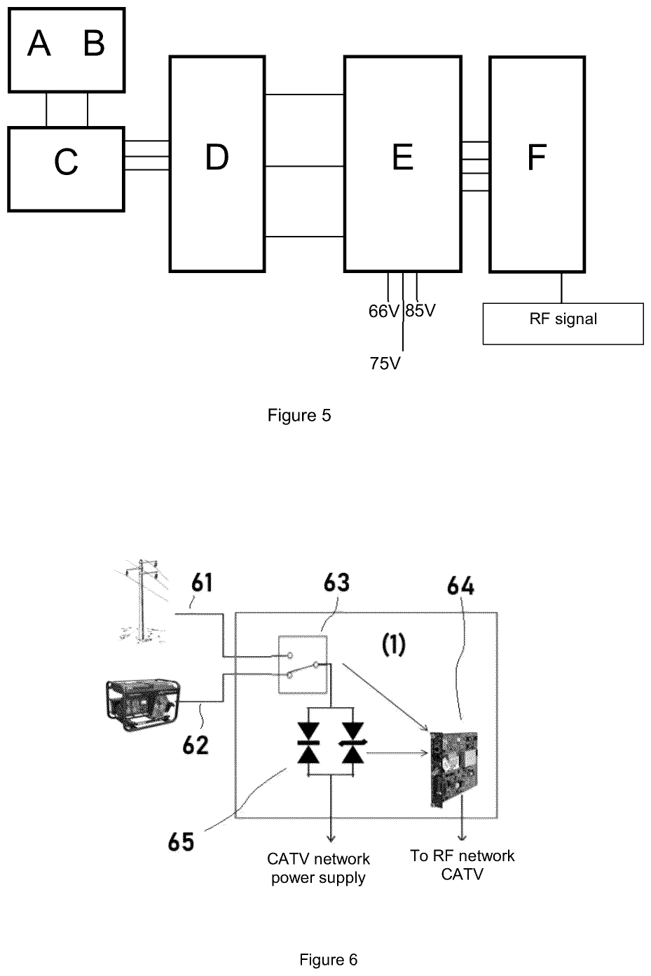

Nomenclature of FIG. 5

A. Main Input.

B. Secondary Input. Second Phase or Generator. Input module automatically selects main or secondary input, with 140 KVA surge suppressor.

C. Soft Start Module, allows circuit breakers not to operate after a blackout, always keeping the Inrush Current low.

D. Transformer Module with 3 Input and Output Voltage options, they can be configured independently on each of the 2 outputs.

E. Voltage Control Module, regulates the Output Voltage to 86±3 Volts for variations of ±15% in the Input Voltage and applies short circuit and overload protections automatically.

F. DOCIS IP Monitoring Module.

The present invention comprises a series of devices that work together to back up a nodal branch of a cable TV network that has been affected by a power failure, from another branch with normal electrical supply, or either, from an auxiliary generator.

A cable TV network is mainly composed of several sections or branches, called nodal branches, which in turn comprise a variety of active equipment and components that are responsible for providing the signal to users at the appropriate levels and parameters.

Through the interconnection of the different circuits, energy can be redirected from an area with electrical supply to an area where there is a power supply deficiency, and applying a good equipment positioning strategy, an integral backup system, in which each branch supports the others in the network can be achieved.

The equipment proposed for this system is compatible with other existing equipment, and perfectly operational on its own, which enables a wide range of possible network configurations. Nevertheless, in a preferable execution version, an area or nodal circuit should at least include:
An “EPS” sine-wave power supply (1)
An “IPSU” intelligent power supply switch (2)
An “IVA” intelligent voltage amplifier (3)

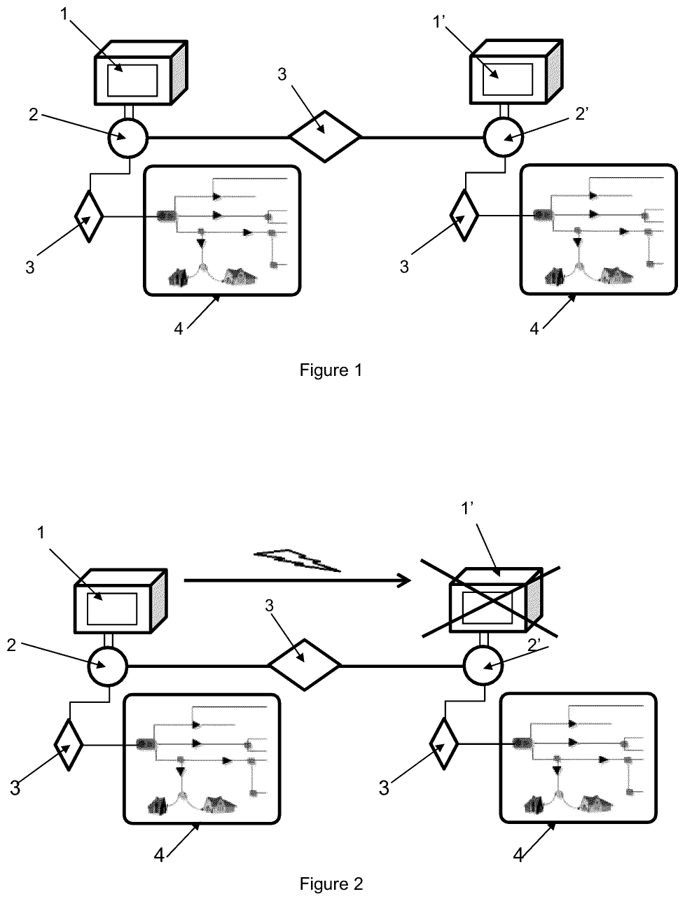

As shown in FIG. 1, under normal conditions, without any utility power outages, the EPS power supplies (1) provide electricity to the entire branch circuit. Local load (4) represents the set of active elements, optical node plus its associated network amplifiers, which interconnected with each other allow to provide cable TV, Internet and telephony services in an area connected to that nodal branch.

The IPSU switches (2), in this situation, act as power blockers to the other branches and the IVA amplifiers (3) compensate the voltage drop due to the resistance of the coaxial cables in the interconnection of the IPSUs or the extension of the distances of the cascaded equipment from the node.

When there is a power outage in any of the power supplies, as shown in FIG. 2, the IPSU switches (2) automatically make the connection change so that the circuit with power backs up the one without. Again, the IVA amplifiers (3) compensate for the ohmic loss between the IPSU switches (2) and the local loads (4), but in addition, an extra IVA amplifier (3) compensates for the voltage drop on the line connecting the IPSUs (2) in each branch.

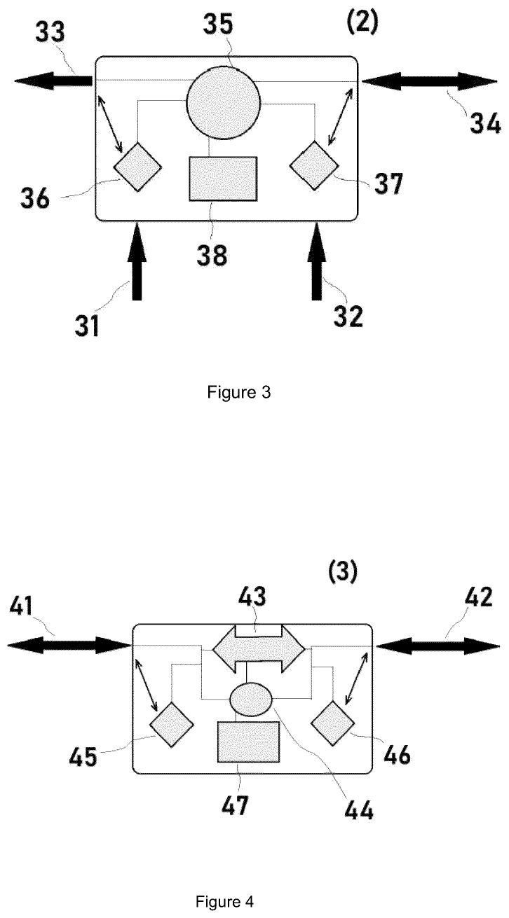

Each IPSU switch (2), as shown in FIG. 3, has two power input ports, which are fed from the EPS P.S. (1).

Input 1 (31) is connected to output port 3 (33) for powering the local load (4) through the switch (35) and, in turn, it has a sensor (36) that permanently monitors that there is voltage at the AC input port (31).

Under normal circumstances, as previously explained, each EPS (1) feeds its own load (4).

Input 2 (32) is linked to remote load port 4 (34) and has a dual voltage control through a sensor (37). It monitors the presence of power at AC input 2 (32) and the voltage at input/output connector 4 (34). In the event of detecting a total, or significant partial voltage drop according to specifications at the remote load (34), the switch (35) is triggered to allow power to flow from port 2 (32) to port 4 (34) and thus back up the EPS P.S. (1′) from the other circuit through and IPSU switch (2′) located on the other branch.

The IPSU switch (2′) of the second nodal branch operates in a complementary way to the IPSU (2) of the first branch. They are exactly the same in components and operation, except that the IPSU (2′) of the second nodal branch turns on with a 3-second delay regarding the IPSU (2) of the first section. This differentiation is forced so that, in the event of a blackout, when the electricity flow returns, both IPSUs don't start at the same time with the risk of causing a short-circuit if the EPS power supplies of each branch are connected to different phases.

Upon failure of the EPS (1′) P.S. of the second circuit, the IPSU (2′) detects the lack of tension through the sensor (36) associated with the input port 1 (31) and triggers the switch (35) to allow the flow of current from the “in/out” connection of the remote load (34) to the local load output port 3 (33).

The whole switching and power backup process occurs in less than 18 milliseconds, so the user does not notice image cuts or interruptions of any kind in the TV set, modem, computer, or any other signal receptor equipment.

The IPSU equipment includes, additionally, a remote monitoring system (38) that sends information from a special port to a transponder located in the EPS power supplies. The monitoring system (38) also offers the possibility of controlling the parameters on-site, through a display and with the option of reading via Bluetooth, so that technicians can obtain precise information on which power supplies are in operation, voltage values and consumptions, without the need for special instruments.

All IPSU connection elements, such as relays, triacs or diode bridges are standard components, and can therefore be easily replaced in case of discontinuity, with no major difficulty.

Since cable TV networks are usually laid over long distances, the ohmic loss produced by the resistance of the coaxial cables needs to be considered. For this reason, voltage amplifiers are usually installed after the switches.

Voltage amplifiers are placed between an IPSU switch and the last active element before the local load, such as an amplifier or circuit node, to enable the active equipment furthest away from the power supply to be reached with voltage values by the required specifications and ranges. It is also necessary to compensate for the voltage drop on the support line connecting two IPSU switches of two different branches, so that when backup is required, the IPSU that receives power from the support circuit does so at the same voltage it would get from its own EPS power supply.

When all the branches are in normal conditions, with no power failures, the IVA voltage amplifiers mounted on the support line operate in passive mode.

Ideally, a bidirectional intelligent voltage amplifier IVA is used, which has two “in/out” ports (41) and (42), associated respectively with sensors (45) and (46) that permanently monitor the presence or absence of power on the lines and are responsible for activating a switch (44) that changes the direction of the amplifier (43).

Like the IPSU switches, the intelligent amplifiers IVA include a monitoring device (47) so that technical staff can permanently control the operating parameters.

Typically, the output voltages delivered by IVA amplifiers are around 60V or 90V, depending on the local norm, as these are the standard operating voltages in cable TV networks.

These same values are supplied at the output of the EPS power supplies, which also optimize energy efficiency as they are sinusoidal.

The EPS are double sinusoidal power supplies that operate with up to 25 Amp, while ordinary power supplies used in cable TV networks develop a maximum of 15 Amp, which is the maximum design current of the active equipment used in this field.

They allow voltage inputs at 110V, US standard; or 230V, EU standard; with an average tolerance of ±15%, though it could optionally be ±25%; and a 40-60 Hz frequency. As illustrated in the diagram of FIG. 6, besides the regular AC input (61), it has an auxiliary input for generators (62), which is used in cases of general power outages or blackouts. They are controlled by an automatic phase selector module (63) that makes the connection switch when the auxiliary generator is disconnected once the electrical supply is restored.

This phase selector module (63) includes a surge suppressor (65) of up to 140 kVA, against atmospheric discharges. The insulators that make up the surge suppressor (65) degrade as they receive atmospheric discharges or lightning strikes, so they must be periodically replaced.

The progression of the deterioration is monitored by a control system (64) to make the replacement when the insulator has reached the end of its useful life time. This control system (64) is also in charge of collecting and processing the data received by the control devices located in the IPSU switches (38) and those located in the IVA amplifiers (47).

Ideally, DOCSIS-compatible data control and transfer modules are used, as this is a widely deployed standard in the industry.

Through the DOCSIS control systems, technicians can obtain accurate information, on-site or remotely, about the current or voltage values at which the equipment is operating, whether it is on active or passive status, possible component failures, among other relevant parameters regarding the performance of the different devices of the nodal circuits. By means of the DOCSIS IP platform, all this information is monitored from a general control center, from where the corrective measures to be taken, if necessary, are defined.

The core of the EPS power supplies is the transformer module, which is in charge of adjusting the voltages of the electricity network to the operating voltage of the cable TV network equipment.

The transformer module has a nominal 110 V or 220 V input with a frequency of 50 Hz or 60 Hz and a 60 V or 90 V output. The values to be used will depend on the power utility voltage in the city where the cable TV network is installed, and the output voltage will depend on the technical features of the active elements of the cable TV operator's network.

Since the nominal voltage may vary depending on the sector of the electricity grid where the EPS is connected, the transformer module has three adaptable input ports. The output of the module also has three ports of 66 V, 75 V and 85 V respectively.

As with all ferromagnetic equipment, when the EPS power supply starts up, a magnetization current is produced in the transformer, which is transient, but can exceed ten times the transformer's nominal current.

To mitigate this unwanted effect, which can produce from a triggering of the safety thermomagnetic circuit breakers to more serious consequences that could affect the entire network, the EPS power supply also includes a controlled start module.

This controlled start module consists of an electronic board with a series of “Diacs” and “Triacs” that cause the voltage to increase gradually during the start-up stage, avoiding abrupt and undesired current peaks. The start-up process until the EPS comes into operation takes only a few seconds.

Finally, the EPS features a voltage control module to stabilize the output voltage. The voltage is regulated to 86±3V for up to ±15% variations in the selected input voltage and short-circuit and surge protections trigger automatically.

Having sufficiently described my invention, which I consider to be a novelty, I therefore, claim as my exclusive property the contents of the following claims:

1. A power backup system for cable TV networks comprising:
a coaxial line connecting two nodal sections of a cable TV network, wherein each nodal section comprises:
at least one alternating current power supply to power the corresponding nodal section,
at least one intelligent switching device connected to an output of the alternating current power supply and
at least one voltage amplifier to compensate for voltage losses between the alternating current power supply and other active network terminals or equipment;

2. The power backup system for cable TV networks according to claim 1, wherein the coaxial line connecting the two nodal sections comprises a voltage amplifier.

3. The power backup system for cable TV networks according to claim 1, wherein the coaxial line connecting the two nodal sections extends from the intelligent switch of a first section to the intelligent switch of a second one.

4. The power backup system for cable TV networks according to the claim 1, wherein the power supply of the nodal section is a sine-wave and comprises:
a standard alternating current input port from the utility power grid,
an auxiliary alternating current input port for emergency generators,
an automatic phase selector to switch the connection depending on where the power is coming from,
a transformer module to adjust the nominal input voltage to a standard voltage operation value for active cable TV network equipment,
a soft-start module to increase the voltage input to the transformer module gradually to avoid current peaks,
a surge suppressor for atmospheric discharges,
a voltage regulator module to stabilize the output voltage of the transformer module, and
two alternating current output ports.

5. The power backup system for cable TV networks according to claim 1, wherein the intelligent switching device of the nodal section comprises:
two alternating current input ports coming from the sine-way power supply,
an AC output port associated with the local load of the nodal section where the device is mounted,
an AC input/output port associated with the backup coax line that connects both nodal sections,
an automatic switch that makes the connection change between the aforementioned ports,
two voltage sensors that constantly monitor the presence or absence of voltage at each of the ports and command the automatic switch to make the connection changes.

6. The power backup system for cable TV networks according to claim 1, wherein the coaxial lines and the nodal sections include voltage amplifiers having:
two AC input/output ports,
an automatic switch that makes a change in the amplification direction, allowing the amplifier device to operate in a bidirectional way,
two voltage sensors, associated respectively to both input/output ports, which command the switch to perform the change of direction.

7. The power backup system for cable TV networks according to claim 6, wherein the power supply, intelligent switches and the voltage amplifiers comprise a data over cable service interface specification (DOCSIS) compliant monitoring and communication system; and

8. The power backup system for cable TV networks according to claim 1, wherein intelligent switches of different nodal branches are sequenced for a delayed startup.
